(19) United States
(12) Patent Application Publication
(10) Pub. No.: US 2016/0020654 A1
(43) Pub. Date: Jan. 21, 2016

(54) LAMINATED ROTOR CORE OF A ROTATING ELECTRIC MACHINE

(71) Applicant: SIEMENS AKTIENGESELLSCHAFT, 80333 Munchen (DE)

(72) Inventor: CHRISTIAN FINGER, Bad Kissingen (DE)

(73) Assignee: SIEMENS AKTIENGESELLSCHAFT, 80333 Munchen (DE)

(21) Appl. No.: 14/801,466

(22) Filed: Jul. 16, 2015

(30) Foreign Application Priority Data
Jul. 17, 2014 (EP) 14177453.9

(51) Int. Cl. H02K 1/27; H02K 1/28

(52) U.S. Cl. CPC H02K 1/2773; H02K 1/28

(57) ABSTRACT

A laminated rotor core of a rotating electric machine includes a base body having a tubular shape with a number of axial rotor segments which project radially outwards. A block magnet is connected by a form fit to the base body, and an individual segment is connected by a form fit to the block magnet and arranged between two of such block magnets which are disposed between two neighboring ones of the rotor segments. The individual segment has a surface which faces the block magnet and includes an individual segment spring element upon which the block magnet rests. The individual segment spring element is configured as an axial contact lug which extends in parallel relationship to a slot of the individual segment in an edge area in which the contact lug is disposed.

### CROSS-REFERENCES TO RELATED APPLICATIONS

This application claims the priority of European Patent Application, Serial No. 14177453.9, filed Jul. 17, 2014, pursuant to 35 U.S.C. 119(a)-(d), the disclosure of which is incorporated herein by reference in its entirety as if fully set forth herein.

### BACKGROUND OF THE INVENTION

The present invention relates to a laminated rotor core of a rotating electric machine.

The following discussion of related art is provided to assist the reader in understanding the advantages of the invention, and is not to be construed as an admission that this related art is prior art to this invention.

Laminated rotor cores of rotating electric machines generally consist of a number of components which are connected to one another. These components are connected to one another for example by gluing, bandaging and/or by means of tensioning rods, bolts, tie rods, end disks and/or end plates.

It would therefore be desirable and advantageous to provide an improved laminated rotor core of a rotating electric machine to obviate prior art shortcomings.

### SUMMARY OF THE INVENTION

According to one aspect of the present invention, a laminated rotor core of a rotating electric machine includes a base body having a tubular shape with a number of axial rotor segments which project radially outwards, a block magnet connected by a form fit to the base body, and an individual segment connected by a form fit to the block magnet and arranged between two of said block magnet which are disposed between two neighboring ones of the rotor segments, the individual segment having a surface which faces the block magnet and includes an individual segment spring element upon which the block magnet rests, the individual segment spring element being configured as an axial contact lug which extends in parallel relationship to a slot of the individual segment in an edge area in which the contact lug is disposed.

Since the base body, the individual segment and the block magnet are designed so that they are connected in a form fit, no additional components which do not contribute to the actual electromagnetic function of the laminated rotor core, such as glue, bandages, tensioning rods, bolts, tie rods, end disks or end sheets, are needed. This advantageously simplifies the assembly of the laminated rotor core and also advantageously reduces the manufacturing costs of the laminated rotor core.

According to another advantageous feature of the present invention, the base body and/or the individual segment can have a punch-bundled configuration. This makes possible an advantageous manufacturing of the base body and/or at least one individual segment in each case as a continuous laminated core from steel strip.

It will be understood by persons skilled in the art that the term “axial course” or “axial direction” relates to a course or a direction in parallel to an axis of rotation of the laminated core. A radial course or a radial direction correspondingly relates to a course or a direction at right angle to the axis of rotation and towards the axis of rotation or away from the axis of rotation.

A base body with rotor segments projecting outwards and running axially advantageously makes it possible to dispose block magnets and/or individual segments between the rotor segments. Accordingly two block magnets and an individual segment disposed between the two block magnets are disposed between two neighboring rotor segments. As a result, the rotor segments and individual segments can advantageously be distributed regularly and alternately along the circumference of the laminated rotor core and a block magnet is disposed in each case between an individual segment and a rotor segment.

According to another advantageous feature of the present invention, the base body can have an axially and radially extending base body groove for engagement of the block magnet, with the base body groove having a radial extent which corresponds to a radial extent of the block magnet so as to fix the block magnet radially. As a result, the block magnets are advantageously connected by a form fit with the base body via the base body grooves.

According to another advantageous feature of the present invention, the individual segment can have an axially and radially extending individual segment groove for engagement of the block magnet, with the individual segment groove having a radial extent which corresponds to a radial extent of the block magnet. In this way, a block magnet and an individual segment are advantageously connected to each other by a form fit in each case via an individual segment groove.

According to another advantageous feature of the present invention, the base body can have at least one surface which faces the block magnet and includes a base body spring element upon which the block magnet rests. By means of the base body spring element and individual segment spring elements production tolerances of the base body, of the individual segments and/or of the block magnets can advantageously be compensated for. In addition the laminated rotor core can advantageously be tensioned by means of the base body spring elements and individual segment spring elements, so that after the assembly of the base body, the individual segments and the block magnets, a compact and stiff rotor core realized.

According to another advantageous feature of the present invention, the base body spring element can be configured as an axial contact lug which extends in parallel relationship to a slot of the base body in an edge area in which the contact lug is disposed.

The effect of the slot disposed behind a contact lug is that a part of the edge area of the base body or of the individual segment having the contact lug is able to be deformed elastically into the slot.

According to another advantageous feature of the present invention, the block magnet can have a rectangular shape. As a result, a block magnet has a simple geometrical shape and can be realized especially cost-effective.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a cross-sectional view of a laminated rotor core of a rotating electric machine in accordance with the present invention;

FIG. 2 shows an enlarged detailed view of the laminated rotor core of FIG. 1; and

FIG. 3 shows an enlarged detailed view of the laminated rotor core of FIG. 2.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

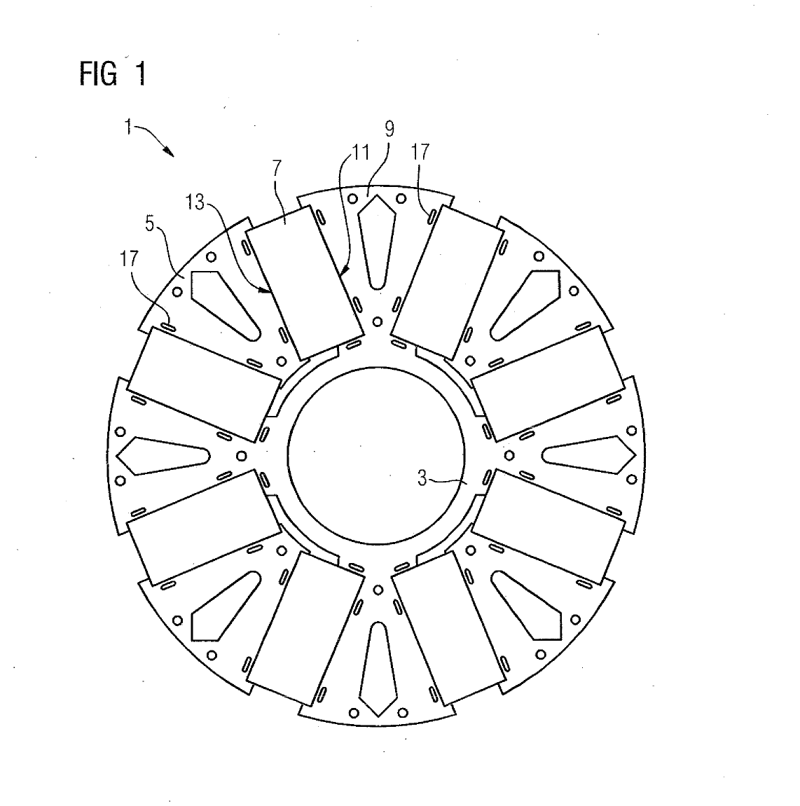

Turning now to the drawing, and in particular to FIG. 1, there is shown a cross-sectional view of a laminated rotor core according to the present invention, generally designated by reference numeral 1, for a rotating electric machine. The laminated rotor core 1 includes a base body 3, a number of individual segments 5 and a number of rectangular block magnets 7. The base body 3 has a tubular shape with a number of rotor segments 9 projecting outwards and running axially. In this case two block magnets 7 and an individual segment 5 disposed between the two block magnets 7 are disposed in each case between two neighboring rotor segments 9.

The block magnets 7 disposed between two rotor segments 9 and the individual segment 5 disposed between the block magnets 7 are connected by a form fit to one another and to the two rotor segments 9. To this end, the base body 3, for each block magnet 7 in contact with it, has a base body groove 11 running axially and radially in a rotor segment 9, into which the block magnet 7 projects and of which the radial extent corresponds to the radial extent of the block magnet 7, so that it fixes the block magnet 7 radially. Furthermore each individual segment 5, for each block magnet 7 in contact with it, has an individual segment groove 13 running axially and radially, into which the block magnet 7 projects and the axial extent of which corresponds to the radial extent of the block magnet 7.

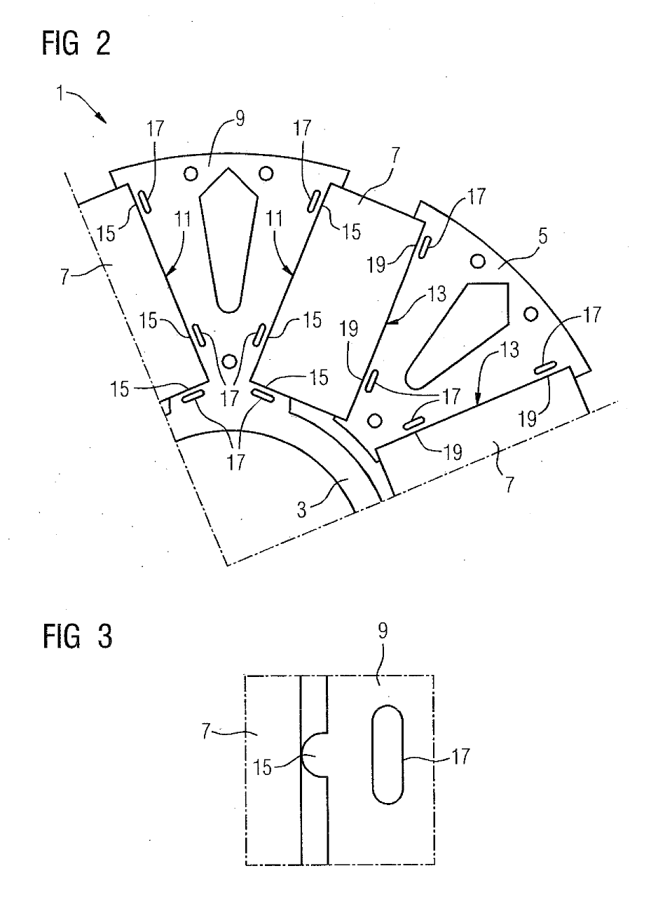

As can be seen in FIG. 2, which is an enlarged detailed view of the laminated rotor core 1, each base body groove 11 has a number of base body spring elements 15, against which the block magnet 7 projecting into the base body groove 11 rests.

FIG. 3 shows such a base body spring element 15 by way of a cross-sectional view. Each base body spring element 15 is embodied as a contact lug running axially, behind which a slot 17 runs in an edge area of the base body 3 in parallel to the contact lug, so that a part of the edge area having the contact lug is able to be deformed elastically into the slot 17.

Two contact lugs run in each base body groove 11 in the slot base of the base body groove 11 and a third contact lug runs in a rotor center-side groove wall of the base body groove 11.

Each individual segment groove 13 has two individual segment spring elements 19, against which the block magnet 7 projecting into the individual segment groove 13 rests. Similar to a base body spring element 15 shown in FIG. 3, each individual segment spring element 19 is also embodied as a contact lug running axially, behind which in an edge area of the individual segment 5 a slot 17 runs parallel to the contact lug, so that a part of the edge area having the contact lug is able to be deformed elastically into the slot 17. In this case the two contact lugs run in the slot base of the individual segment slot 13.

The base body spring elements 15 and the individual segment spring elements 19 have the same manufacturing tolerances of the base body 3, the individual segments 5 and/or the block magnets 7 and also insure that the laminated rotor core 1 is tensioned, so that after the assembly of the base body 3, the individual segments 5 and the block magnets 7, a compact and stiff laminated rotor core 1 exists.

The base body 3 and/or the individual segments 5 are preferably a punch-bundled design.

The exemplary embodiment of a laminated rotor core 1 depicted in FIGS. 1 to 3 has four individual segments 5 and rotor segments 9 and eight block magnets 7 in each case. Other exemplary embodiments make provision for a different number of individual segments 5 and rotor segments 9 and a corresponding number of block magnets 7 and/or a different number of individual segment spring elements 19 in an individual segment groove 13 and/or base body spring elements 15 in a base body groove 11, but apart from this are designed in a similar way to the exemplary embodiment shown in FIGS. 1 to 3.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A laminated rotor core of a rotating electric machine, comprising:
a base body having a tubular shape with a number of axial rotor segments which project radially outwards;
a block magnet connected by a form fit to the base body; and
an individual segment connected by a form fit to the block magnet and arranged between two of said block magnet which are disposed between two neighboring ones of the rotor segments, said individual segment having a surface which faces the block magnet and includes an individual segment spring element upon which the block magnet rests, said individual segment spring element being configured as an axial contact lug which extends in parallel relationship to a slot of the individual segment in an edge area in which the contact lug is disposed.

2. The laminated rotor core of claim 1, wherein the base body has a punch-bundled configuration.

3. The laminated rotor core of claim 1, wherein the individual segment has a punch-bundled configuration.

4. The laminated rotor core of claim 1, wherein the base body has an axially and radially extending base body groove for engagement of the block magnet, said base body groove having a radial extent which corresponds to a radial extent of the block magnet so as to fix the block magnet radially.

5. The laminated rotor core of claim 1, wherein the individual segment has an axially and radially extending individual segment groove for engagement of the block magnet, said individual segment groove having a radial extent which corresponds to a radial extent of the block magnet.

6. The laminated rotor core of claim 1, wherein the base body has at least one surface facing the block magnet and including a base body spring element upon which the block magnet rests.

7. The laminated rotor core of claim 6, wherein the base body spring element is configured as an axial contact lug which extends in parallel relationship to a slot of the base body in an edge area in which the contact lug is disposed.

8. The laminated rotor core of claim 1, wherein the block magnet has a rectangular shape.
